(19) United States
(12) Patent Application Publication
(10) Pub. No.: US 2022/0003156 A1
(43) Pub. Date: Jan. 6, 2022

(54) Device for Injecting Water into a Combustion Chamber or into an Intake Tract of an Internal Combustion Engine

(71) Applicant: Robert Bosch GmbH, Stuttgart (DE)

(72) Inventors: Martin Riegel, Ceské Budejovice (CZ); Petr Novak, Ceské Budejovice (CZ); Radek Malec, Ceské Budejovice (CZ)

(21) Appl. No.: 17/294,975

(22) PCT Filed: Nov. 13, 2019
(86) PCT No.: PCT/EP2019/081153

§ 371 Date: May 18, 2021

(30) Foreign Application Priority Data
Nov. 28, 2018 (DE) 10 2018 220 394.6

(51) Int. Cl. F02B 47/02; F02M 25/028; F02M 25/022; F02M 25/03; F16L 41/08; F16L 55/027

(52) U.S. Cl. CPC F02B 47/02; F02M 25/028; F16L 55/027; F02M 25/03; F16L 41/088; F02M 25/0224

(57) ABSTRACT

A device for injecting water into a combustion chamber or into an intake tract of an internal combustion engine includes a rail and at least one injection valve connected to the rail. The connection is produced by means of a rail cup, which surrounds the injection valve at the rail-side end of the injection valve. The injection valve has a feed channel open toward the rail, in which feed channel at least some portions of an insert are received in order to reduce the feed cross-section.

The invention relates to a device for injecting water into a combustion chamber or into an intake tract of an internal combustion engine having the features of the preamble of claim 1. The internal combustion engine may, in particular, be a gasoline engine.

### PRIOR ART

To reduce carbon dioxide emissions, it is essential to optimize the fuel consumption of internal combustion engines, for example by increasing compression or by downsizing concepts in combination with turbocharging. However, at high engine loads, operation of the internal combustion engine at an operating point which would be optimal with respect to fuel consumption is generally not possible since operation is limited by the tendency for knock and by high exhaust gas temperatures. Measures for reducing the tendency for knock and/or for lowering the exhaust gas temperatures provide for the injection of water, it being possible for injection to take place directly into a combustion chamber of the internal combustion engine or into an intake tract of the internal combustion engine.

In internal combustion engines with water injection, there is the risk that water-carrying lines and/or components will freeze at low temperatures and will be damaged by ice pressure. To prevent this, the water-carrying lines and/or components are generally emptied when the engine is switched off.

By way of example, DE 10 2015 208 472 A1 discloses an internal combustion engine with a water injection device which comprises a water tank for storing water, a pump for delivering the water and a water injection valve for injecting water. The pump is connected on the inlet side, via a first line, to the water tank and on the outlet side, via a second line, to the water injection valve. For simple emptying of the pump, the latter is arranged above the water tank, enabling it to be emptied by gravity. Alternatively or additionally, the pump can be operated in the reverse delivery direction.

To avoid icing of the injection valves of an injection system of this kind, they must also be emptied. German Laid-Open Application DE 10 2015 208 508 A1 discloses a water injection device for an internal combustion engine which comprises at least two injection valves or water injectors, which are emptied one after the other by reversing the delivery direction of a delivery unit. Consequently, the injection valves or water injectors do not have to be designed to be resistant to ice pressure. Emptying the injection valves one after the other is intended to ensure the safe removal of any water that is present. The air sucked in via the open injection valves during emptying is intended to additionally assist emptying.

The object underlying the invention is that of specifying a device for injecting water into a combustion chamber or into an intake tract of an internal combustion engine, which device can be emptied as simply and quickly as possible in order to avoid icing and associated ice pressure damage.

In order to achieve the object, the device having the features of claim 1 is proposed. Advantageous developments of the invention can be found in the dependent claims.

### DISCLOSURE OF THE INVENTION

The proposed device for injecting water into a combustion chamber or into an intake tract of an internal combustion engine comprises a rail and at least one injection valve connected to the rail. The connection is produced by means of a rail cup, which surrounds the injection valve at the rail-side end thereof. According to the invention, the injection valve has a feed channel open toward the rail, in which feed channel at least some section or sections of an insert is/are received in order to reduce the feed cross section.

The insert reduces the free flow cross section of the feed channel, with the result that the flow velocity in the feed channel increases. This has an advantageous effect particularly when emptying the injection valve by means of reverse suction since the injection valve is emptied more quickly. In the region of the injection valve/rail interface, the volume to be emptied usually has a particularly large cross-sectional area, and therefore the advantages of the invention are particularly evident here. It is advantageous if the insert extends over the entire length of the feed channel, thus ensuring that the positive effect is achieved over the entire length of the feed channel. As a further preference, the insert is such that the free flow cross section is approximately constant over the length of the insert and/or of the feed channel. This ensures that the flow through the feed channel is as uniform as possible.

A further advantage results from the fact that the dead volume in the injection valve can be reduced with the aid of the insert. This means that there is less volume to be emptied when the internal combustion engine is switched off. Accordingly, this measure too contributes to speeding up emptying.

According to a preferred embodiment of the invention, the insert, preferably a hollow cylindrical projection of the insert, projects into the rail. This means that the insert projects beyond the inner wall of the rail. Since the injection valves are usually attached to the rail from below, the inward-protruding or projecting part of the insert can be used to form a threshold which prevents any water that remains in the rail from flowing back into the injection valve after the reverse suction process. As a result, the injection valve is even better protected against ice pressure damage.

As an alternative or additional proposal, the insert, preferably a flange section of the insert, has an outside diameter which is the same as or slightly larger than an inside diameter of the rail cup. The insert or flange section thus comes to rest on the circumference of the rail cup, and therefore the insert at least largely fills the volume of the rail cup. Accordingly, the dead volume in the rail cup is reduced, and therefore this too is emptied more quickly. Insofar as the insert or the flange section has a radial oversize, it is simultaneously possible to achieve a seal by means of the flange section since the latter bears against the rail cup under a radial preload. The flange section may thus be able to replace a sealing ring.

In a further development of the invention, it is proposed that the insert, preferably a collar section of the insert, engages around the injection valve at the rail-side end thereof. A corresponding insert can be produced in a simple manner by overmolding. This ensures an optimum connection between the insert and the injection valve. Furthermore, the volume of the rail cup can be better filled.

It is advantageous if the insert is produced from an elastomer material and has a radial oversize in some section or sections, preferably in the region of the collar section, with respect to the inside diameter of the rail cup. The use of the elastomer material makes it possible to use the insert as a sealing element which seals the feed region from the outside. In this function, the insert is able to replace the sealing ring that is usually arranged between the injection valve and the rail cup. The radial oversize ensures radial preloading of the insert with respect to the rail cup, the preloading force being at the same time a sealing force.

As a further development measure, it is further proposed that, at least in some region or regions, preferably at least in the region of a surface facing the feed channel, the insert is produced from a material which is more hydrophilic than the material of a body in which the feed channel is formed. The feed channel is usually formed in a body, in particular a valve body, of the injection valve, which body is made of metal, for example stainless steel. If, on the other hand, the insert is produced at least in some region or regions from a material which is more hydrophilic, preferably significantly more hydrophilic, than the material of the body, water remaining in the injection valve can be “sucked in” with the aid of the insert by means of adsorption and transported into the rail. In this way, the insert assists rapid and as complete as possible emptying of the injection valve. The insert is preferably made of a corresponding material over its entire length—at least in the region of the surfaces which come into contact with water.

It is furthermore proposed that the insert extends in the axial direction over at least half the length of the injection valve, preferably over at least two-thirds of the length of the injection valve, and furthermore preferably over at least three-quarters of the length of the injection valve. The length of the injection valve is substantially predetermined by the axial distance between an injection opening of the injection valve and the outlet of the feed channel at the rail-side end of the injection valve. The longer the insert is, the less dead volume that must be emptied to avoid ice pressure damage remains in the injection valve. The insert is preferably passed through an annular solenoid coil of the injection valve, said coil usually being arranged approximately centrally with respect to the axial extent of the injection valve. Since the region having the injection opening is particularly sensitive to ice pressure, the insert can be guided into this region in order to avoid ice pressure damage, and therefore the end of the insert facing the injection opening is closer to the injection opening than to the solenoid coil.

The insert preferably forms at least one channel, which extends in the axial direction and is part of a feed path for the water. This means that the inflow of water takes place at least in some section or sections through the insert. In addition, however, the at least one channel can also be arranged radially on the outside with respect to the insert and can be delimited by the insert and a body, e.g. a valve body, of the injection valve. Accordingly, it is not absolutely necessary for the at least one channel to be bounded or enclosed by the insert over its entire circumference. For example, the insert can have, on its outer circumference, axially extending webs or ribs which define a plurality of channels, which are preferably arranged at equal angular intervals with respect to one another, as a feed path. The feed path can thus run inside and/or outside with respect to the insert in some section or sections. The angular intervals between the webs or ribs can furthermore be selected to be so small that a screening or filtering function is achieved. By virtue of the functional integration, it is possible to dispense with a separate filter, simplifying the construction of the injection valve.

As a further development measure, it is therefore proposed that the insert forms a filter in at least one section. As mentioned above, the filter can be formed by webs and/or ribs that subdivide the feed path. In addition, at least one wall section of the insert can be formed from a screen or filter material. A wall section of the insert can also be designed analogously to a screen or filter material.

According to one advantageous embodiment of the invention, the insert has a first section which forms a prefilter. This is followed downstream—in the main direction of flow of the water—by a further section with a filtering function, the further section preferably forming a fine filter.

Preferred embodiments of the invention are explained in greater detail below with reference to the attached drawings. In the drawings:

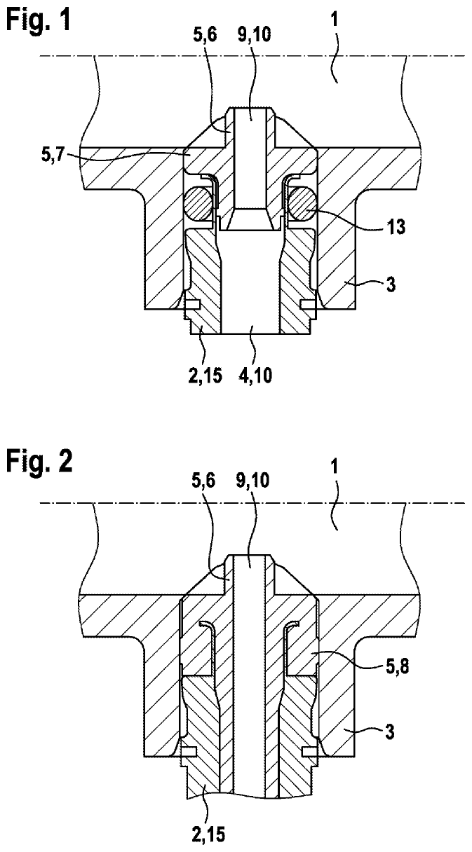

FIG. 1 shows a schematic longitudinal section through a device according to the invention in accordance with a first preferred embodiment,

FIG. 2 shows a schematic longitudinal section through a device according to the invention in accordance with a second preferred embodiment,

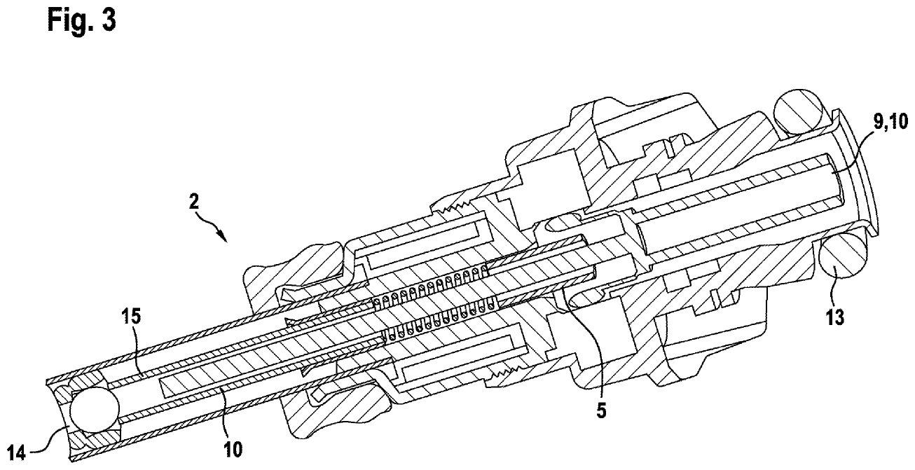

FIG. 3 shows a schematic longitudinal section through a device according to the invention in accordance with a third preferred embodiment,

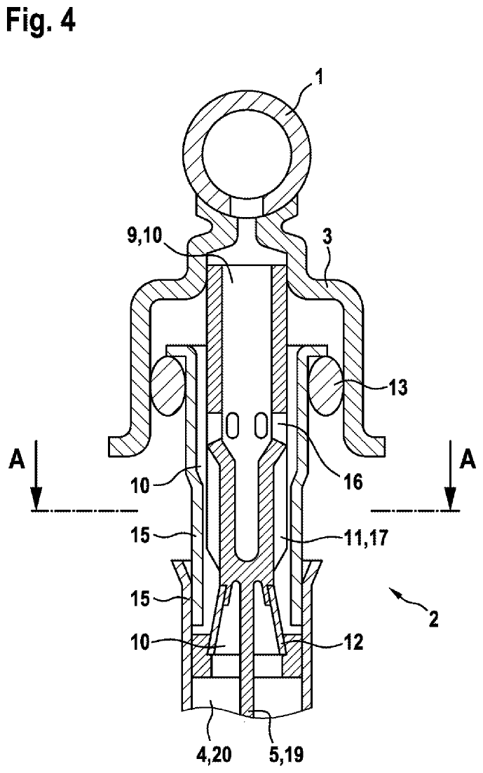

FIG. 4 shows a schematic longitudinal section through a device according to the invention in accordance with a fourth preferred embodiment,

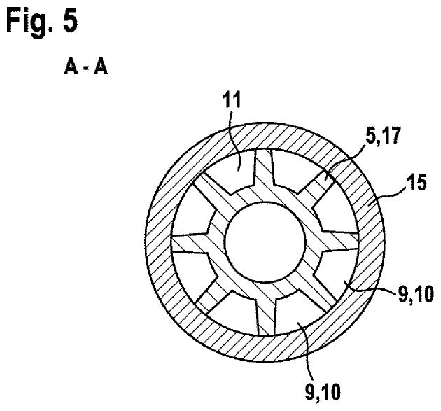

FIG. 5 shows a schematic cross section through the device of FIG. 4, and

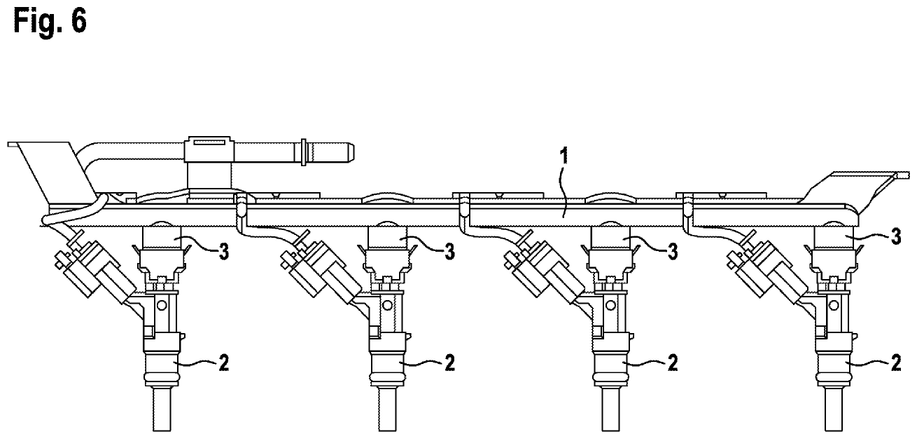

FIG. 6 shows a view of a rail having a plurality of injection valves.

### DETAILED DESCRIPTION OF THE DRAWINGS

FIG. 1 shows a first device according to the invention for injecting water into a combustion chamber or into an intake tract of an internal combustion engine. The device comprises a rail 1, which is tubular and has, in a circumferential region, at least one rail cup 3 for the connection of an injection valve 2. The rail 1 is aligned substantially horizontally, with the result that the rail cup 3 points vertically downwards. The injection valve 2 is accordingly inserted into the rail cup 3 from below during assembly.

The injection valve 2 has a valve body 15, the rail-side end of which forms a feed channel 4 open toward the rail 1. The injection valve 2 is supplied with water from the rail 1 via the feed channel 4. The feed region is sealed off from the outside by a sealing ring 13 arranged on the valve body 15. When the internal combustion engine is switched off, the injection valve 2 and the rail 1 are emptied in order to avoid icing at low outside temperatures. This is because the ice pressure arising during icing could lead to damage to the injection valve 2 and/or to the rail 1. For emptying, the water present in the injection valve 2 or in the rail 1 is sucked back into a water tank. Since a smaller volume can be emptied more quickly, the injection valve 2 illustrated has an insert 5 which reduces the flow cross section of the feed channel 4 and thus reduces the volume to be emptied, hereinafter referred to as dead volume. The insert 5 is such that it fills the volume of the rail cup 3 by means of a flange section 7, the outside diameter of which is matched to the inside diameter of the rail cup 3. The dead volume is thereby further reduced. Furthermore, the insert 5 of FIG. 1 has a hollow cylindrical projection 6, which projects into the rail 1, resulting in the formation of a threshold that prevents any residual water remaining in the rail 1 from flowing back into the injection valve 2. The inflow of water with the rail 1 filled takes place via a channel 9 of the insert 5, in the present case said channel being arranged concentrically or coaxially with the feed channel 4 of the valve body 15. The channel 9 thus forms part of a feed path 10 for the water.

FIG. 2 shows a further device according to the invention for injecting water into a combustion chamber or into an intake tract of an internal combustion engine. In contrast to the device of FIG. 1, the valve body 15 of the injection valve 2 is not surrounded by a sealing ring 13 but by a collar section 8 of the insert 5. The collar section 8 furthermore has a radial oversize with respect to the inside diameter of the rail cup 3, with the result that the insert bears against the inside of the rail cup 3 under a radial preload. The insert 5 thus replaces the sealing ring 13. Moreover, the insert 5 is guided deep into the valve body 15 of the injection valve 2, with the result that the free flow cross section is reduced over a relatively large distance. Accordingly, the dead volume in the injection valve 2 is reduced. The insert 5 shown in FIG. 2 can be produced in a particularly simple manner by overmolding. In particular, a material which, like a sealing material, has a certain elasticity can be selected as the overmolding material.

FIG. 3 shows an injection valve 2 for a device according to the invention which comprises an insert 5 that extends substantially over the entire length of the injection valve 2. This means that the insert 5 extends almost as far as an injection opening 14. The dead volume is thus reduced to a minimum. Moreover, the insert 5 shown in FIG. 3 is made of a hydrophilic material, with the result that adsorption forces cause water to rise within the injection valve 2.

FIG. 3 furthermore clearly shows that the insert 5 does not have to be of sleeve-shaped design all the way along but can have a significantly more complex geometry in order to fill the volume in the injection valve 2, apart from the required feed path 10. Water flowing in the direction of the injection opening 14 can thus flow both through and around the insert 5.

FIGS. 4 and 5 show a further injection valve 2 for a device according to the invention. In this exemplary embodiment, the insert 5 has an even more complex shape. On the rail side, the insert 5 initially forms a central channel 9. Via circumferential openings 16 in the insert 5, the feed path 10 is then directed outward, and therefore the valve body 15, together with the insert 5, delimits the feed path 10. This is followed by a section which has axially extending webs 17 arranged at equal angular intervals with respect to another (see FIG. 5). In the radial direction, the webs 17 extend up to the valve body 15, with the result that channels 9 arranged in a manner distributed over the circumference are formed as a feed path 10. The flow cross section of the channels 9 is selected to be so small that they form a filter 11, preferably a prefilter. The section with the webs 17 is followed by a section which forms a further filter 12, preferably a fine filter. For this purpose, the insert 5 has an integrated cone made of a filter fabric. The end of the cone is supported on an annular section 18 of the insert 5, said section bearing against the valve body 15 under a radial preload and thus preventing the filter 12 from being bypassed. Via the filter 12, the feed path 10 is thus directed back from the radial outside to the radial inside, wherein a centrally arranged pin-shaped section 19 of the insert 5 causes a reduction in the dead volume. The feed path 10 thus runs via an annular space 20 within the feed channel 4.

FIG. 6 shows one possible embodiment of a device according to the invention. By way of example, four injection valves 2 are connected to the rail 1. The connection is made in each case via a rail cup 3.

1. A device for injecting water into a combustion chamber or into an intake tract of an internal combustion engine, comprising:
a rail;
at least one injection valve connected to the rail; and
a rail cup, which surrounds the at least one injection valve at a rail-side end of the at least one injection valve and connects the at least one injection valve to the rail,
wherein the at least one injection valve defines a feed channel that is open toward the rail, and at least one section of an insert is received in the feed channel so as to reduce the feed cross section.

2. The device as claimed in claim 1, wherein the insert projects into the rail.

3. The device as claimed in claim 1, wherein the insert has an outside diameter which is the same as or slightly larger than an inside diameter of the rail cup.

4. The device as claimed in claim 1, wherein the insert engages around the rail-side end of the at least one injection valve.

5. The device as claimed in claim 1, wherein the insert is produced from an elastomer material and has a radial oversize with respect to an inside diameter of the rail cup in at least one portion of the insert.

6. The device as claimed in claim 1, wherein the insert has at least one region that is produced from a material which is more hydrophilic than a material of a body in which the feed channel is formed.

7. The device as claimed in claim 1, wherein the insert extends in an axial direction over at least half a length of the injection valve.

8. The device as claimed in claim 1, wherein the insert defines at least one channel, which extends in an axial direction and is part of a feed path for the water.

9. The device as claimed in claim 1, wherein the insert forms a filter in at least one region.

10. The device as claimed in claim 2, wherein the insert includes a hollow cylindrical projection that projects into the rail.

11. The device as claimed in claim 3, wherein the insert includes a flange section that has the outside diameter.

12. The device as claimed in claim 4, wherein the insert has a collar section that engages around the rail-side end of the at least one injection valve.

13. The device as claimed in claim 5, wherein the insert has a collar section that engages around the rail-side end of the at least one injection valve, and the at least one portion of the insert having the radial oversize is in a region of the collar section.

14. The device as claimed in claim 6, wherein the at least one region of the insert is in a region of a surface facing the feed channel.

15. The device as claimed in claim 7, wherein the insert extends in the axial direction over at least two-thirds of the length of the at least one injection valve.

16. The device as claimed in claim 15, wherein the insert extends in the axial direction over at least three-quarters of the length of the at least one injection valve.
